(19) United States
(12) Patent Application Publication
(10) Pub. No.: US 2020/0246707 A1
(43) Pub. Date: Aug. 6, 2020

(54) PROGRAM AND SYSTEM

(71) Applicant: SQUARE ENIX CO., LTD., Tokyo (JP)

(72) Inventors: Hisanao SUZUKI, Tokyo (JP); Toshio AKIYAMA, Tokyo (JP)

(73) Assignee: SQUARE ENIX CO., LTD., Tokyo (JP)

(21) Appl. No.: 16/639,279

(22) PCT Filed: Aug. 28, 2017
(86) PCT No.: PCT/JP2017/030663

§ 371 Date: Feb. 14, 2020

(51) Int. Cl. A63F 13/69; A63F 13/79; A63F 13/35

(52) U.S. Cl. CPC A63F 13/69; A63F 13/35; A63F 13/79

(57) ABSTRACT

In a case where an in-game element (for example, an item) which becomes a determination target in a video game (for example, a video game that a user currently plays) corresponds to an in-game element that was given to the user in the other video game (for example, a video game that the user played), a user terminal gives the user an in-game element different from the in-game element that became the determination target. In a case where an event of the video game is executed based on a request from the user, an in-game element for which an acquisition condition is satisfied in the event may be set as the determination target. The user terminal may refer to a predetermined storage region to display information regarding an in-game element that corresponds to a given element among a plurality of in-game elements that appears in the video game.

### TECHNICAL FIELD

At least one of embodiments according to the present invention relates to a program for causing a user terminal to realize functions to control progress of a video game. Further, at least one of the embodiments according to the present invention relates to a system for controlling progress of the video game, which includes a communication network, a server, and a user terminal. Further, at least one of the embodiments according to the present invention relates to a program for causing a server to realize functions to control progress of the video game.

### BACKGROUND ART

Heretofore, there has been a video game system in which a user of one video game is induced to the other video game, which is different from the one video game, by taking over game information from the one video game to the other video game.

In such video game systems, there is one in which when game information is taken over from one video game (which is a video game of a takeover source), incentive is given to a user in the other video game (which is a video game of a takeover destination) (see Patent Document 1).

### PRIOR ART DOCUMENTS

### Patent Documents

Patent Document 1: Japanese Patent Application Publication No. 2017-117325

### SUMMARY OF THE INVENTION

### Problems to be Solved by the Invention

However, in such a video game system, a user can acquire incentive without having to continuously play the other video game. For this reason, there has been a case where the user cannot be caused to continuously play the other video game.

It is an object of at least one embodiment of the present invention to provide a user with motive for continuously playing the other video game by using game information of one video game.

### Means For Solving the Problems

According to a non-limiting aspect of the present invention, a program according to one embodiment of the present invention is a program for causing a user terminal to realize functions to control progress of a video game, wherein the functions include: a specifying function configured to specify at least one in-game element as a determination target on a basis of progress of the video game; a determining function configured to refer to a predetermined storage region in which information regarding an in-game element that has been given to a user in the other video game (hereinafter, referred to as a “given element”) is stored, and determine whether the determination target corresponds to the given element or not; and a giving function configured to give the user an in-game element different from the determination target (hereinafter, referred to as a “given target”) in a case where it is determined that the determination target corresponds to the given element.

According to a non-limiting aspect of the present invention, a system according to one embodiment of the present invention is a system for controlling progress of a video game, the system including a communication network, a server, and a user terminal, the system including: a specifying unit configured to specify at least one in-game element as a determination target on a basis of progress of the video game; a determining unit configured to refer to a predetermined storage region in which information regarding an in-game element that has been given to a user in the other video game (hereinafter, referred to as a “given element”) is stored, and determine whether the determination target corresponds to the given element or not; and a giving unit configured to give the user an in-game element different from the determination target (hereinafter, referred to as a “given target”) in a case where it is determined that the determination target corresponds to the given element.

According to a non-limiting aspect of the present invention, a program according to one embodiment of the present invention is a program for causing a server to realize functions to control progress of a video game, wherein the functions include: a specifying function configured to specify at least one in-game element as a determination target on a basis of progress of the video game; a determining function configured to refer to a predetermined storage region in which information regarding an in-game element that has been given to a user in the other video game (hereinafter, referred to as a “given element”) is stored, and determine whether the determination target corresponds to the given element or not; and a giving function configured to give the user an in-game element different from the determination target (hereinafter, referred to as a “given target”) in a case where it is determined that the determination target corresponds to the given element.

### Effects of the Invention

According to each of the embodiments of the present application, one or two or more shortages are solved.

### BRIEF DESCRIPTION OF THE DRAWINGS

FIG. 1 is a block diagram illustrating an example of a configuration of a system corresponding to at least one of the embodiments according to the present invention.

FIG. 2 is a block diagram illustrating a configuration of a server corresponding to at least one of the embodiments according to the present invention.

FIG. 3 is a flowchart illustrating an example of game related processing corresponding to at least one of the embodiments according to the present invention.

FIG. 4 is a flowchart illustrating an example of an operation at a server side in the game related processing corresponding to at least one of the embodiments according to the present invention.

FIG. 5 is a flowchart illustrating an example of an operation of a terminal side in the game related processing corresponding to at least one of the embodiments according to the present invention.

FIG. 6 is a block diagram illustrating a configuration of a server corresponding to at least one of the embodiments according to the present invention.

FIG. 7 is a flowchart illustrating an example of game related processing corresponding to at least one of the embodiments according to the present invention.

FIG. 8 is a block diagram illustrating a configuration of a server corresponding to at least one of the embodiments according to the present invention.

FIG. 9 is a flowchart illustrating an example of display processing corresponding to at least one of the embodiments according to the present invention.

FIG. 10 is a block diagram illustrating a configuration of a system corresponding to at least one of the embodiments according to the present invention.

FIG. 11 is a block diagram illustrating a configuration of a terminal corresponding to at least one of the embodiments according to the present invention.

FIG. 12 is an explanatory drawing for explaining an example of a storage state of information corresponding to at least one of the embodiments according to the present invention.

FIG. 13 is an explanatory drawing for explaining an example of a storage state of information corresponding to at least one of the embodiments according to the present invention.

FIG. 14 is a flowchart illustrating an example of takeover processing corresponding to at least one of the embodiments according to the present invention.

FIG. 15 is a flowchart illustrating an example of game related processing corresponding to at least one of the embodiments according to the present invention.

FIG. 16 is a flowchart illustrating an example of display processing corresponding to at least one of the embodiments according to the present invention.

### DESCRIPTION OF THE EMBODIMENTS

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

(First Embodiment)

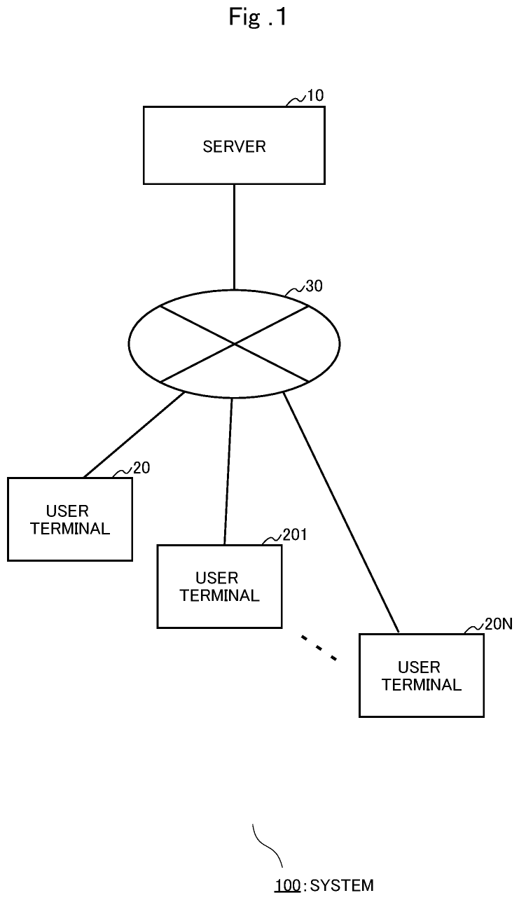

FIG. 1 is a block diagram illustrating an example of a configuration of a system 100 according to one embodiment of the present invention. As illustrated in FIG. 1, the system 100 includes a server 10, and user terminals 20, and 201 to 20N respectively used by users of the system 100 (“N” is an arbitrary integer. Hereinafter, they are simply referred to as “terminals 20, and 201 to 20N”). In this regard, the configuration of the system 100 is not limited to this configuration. The system 100 may be configured so that a plurality of users uses a single terminal, or may be configured so as to include a plurality of servers.

Each of the server 10 and the plurality of terminals 20 and 201 to 20N is connected to a communication network 30 such as the Internet. In this regard, although it is not shown in the drawings, the plurality of terminals 20 and 201 to 20N is connected to the communication network 30 by carrying out data communication with base stations managed by a telecommunication carrier by means of a radio communication line.

The system 100 includes the server 10 and the plurality of terminals 20, and 201 to 20N, thereby executing various kinds of processes to control progress of a video game. The phase “progress of a video game” means various kinds of progress or changes and the like that can be generated in the video game. As examples of the phrase “various kinds of progress or changes and the like that can be generated in the video game”, there are progress of time, a change in a parameter of a game element, update of a specific status or a flag, and the like.

The server 10 is managed by an administrator of the system 100, and has various kinds of functions to provide information regarding the various kinds of processes to each of the plurality of terminals 20, 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processes, such as a control section, as a computer. However, its explanation herein is omitted. Further, in the system 100, it is preferable that the server 10 manages various kinds of information from a point of view to reduce a processing load on each of the plurality of terminals 20, 201 to 20N. However, a storage region may be provided in a state that the server 10 can access the storage region. For example, the server 10 maybe configured so as to be provided with a dedicated storage region outside the server 10.

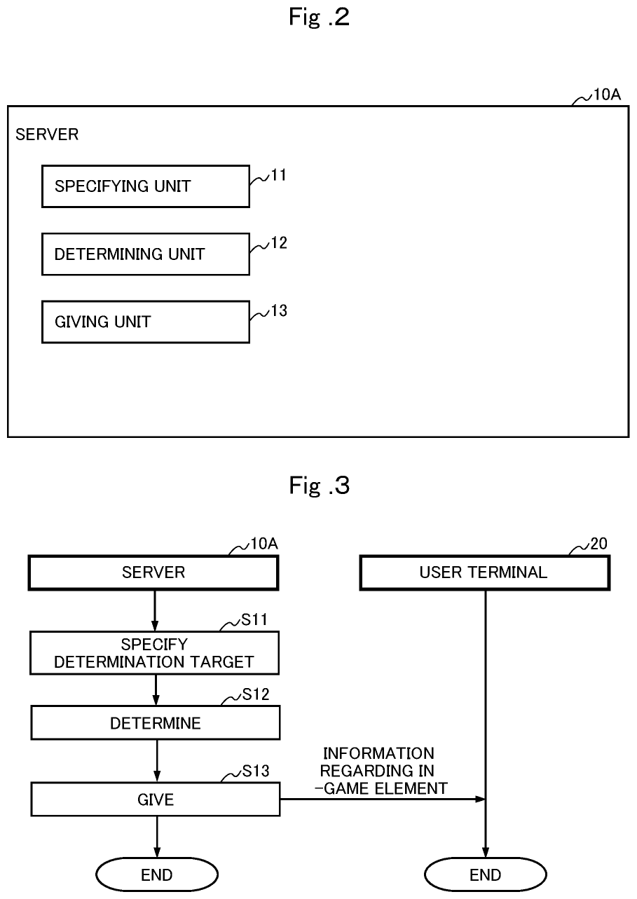

FIG. 2 is a block diagram illustrating a configuration of a server 10A, which is an example of the configuration of the server 10. As illustrated in FIG. 2, the server 10A at least includes a specifying unit 11 (which corresponds to one example of a specifying function), a determining unit 12 (which corresponds to one example of a determining function), and a giving unit 13 (which corresponds to one example of a giving function).

The specifying unit 11 has a function to execute a process for specifying at least one in-game element as a determination target on the basis of progress of the video game. Here, the in-game element means an element that the user can use in the video game. It is preferable that the user can virtually possess a plurality of in-game elements, and use them (for example, equipment or setting). As examples of the in-game element, there are skill, an item, a character, and the like. Further, the determination target means an in-game element that becomes a target for predetermined determination among in-game elements that appear in the video game. A configuration to specify the determination target is not limited particularly. However, it is preferable that it is a configuration in which one that satisfies a predetermined condition to become a determination target is set to the determination target. As examples of such a configuration, there are items each of which is given in a predetermined situation (for example, an item that is decided to be given on the basis of progress of the video game, and an item that is presented from the other player).

The determining unit 12 has a function to execute a process for referring to a predetermined storage region to determine whether the determination target corresponds to an in-game element that was given to the user in the other video game (hereinafter, referred to as a “given element”) or not. Here, the other video game means a video game different from the video game that the user currently plays. A relation between the video game that the user currently plays and the other video game is not limited particularly. As an example of the relation between the video game that the user currently plays and the other video game, there is a relationship between a latest video game (the video game that the user currently plays) and a previous game (the other video game) in a series of video games. Further, the phrase “the determination target corresponds to a given element” means that the determination target and the given element have a predetermined relationship. As an example of the case where the determination target corresponds to a given element, there is a relationship that the determination target and the given element are the same as each other or are considered to be the same as each other. As another example thereof, there is a relationship that an in-game element obtained by evolving a determination target is the same as a given element or is considered to be the same as the given element. As still another example, there is a relationship that an in-game element before evolution of a determination target is the same as a given element or is considered to be the same as the given element. A configuration to determine whether the determination target corresponds to the given element or not is not limited particularly. However, it is preferable to determine it by referring to a storage region in which information regarding the determination target is stored and a storage region in which information regarding the given element is stored and comparing the information regarding the determination target with the information regarding the given element. As an example of such a configuration, there is one in which whether the determination target and the given element have a relationship that identification information of the determination target is the same as identification information of the given element or is considered to be the same as identification information of the given element is determined. Further, the server 10A may be configured so that the determining unit 12 refers to the predetermined storage region to determine whether the determination target and the given element are stored therein so as to be associated with each other, thereby determining whether the specified determination target correspond to the given element or not.

The giving unit 13 has a function to execute a process for giving the user an in-game element. Further, the giving unit 13 also has a function to execute a process for giving the user an in-game element different from the determination target (hereinafter, referred to as a “given target”) in a case where it is determined that the determination target corresponds to the given element. A plurality of in-game elements may be included in the in-game element that becomes the given target. Here, the in-game element different from the determination target means an in-game element that is dealt with as other one than the determination target. As an example of the in-game element different from the determination target, there are in-game elements whose parameters (for example, a level or ability) are different from each other. Further, the relation between the given target and the determination target is not limited particularly. However, it is preferable that the given target is an in-game element that has a higher value than that of the determination target. As an example of the configuration to give the user the given target, there is a configuration in which an in-game element whose value of a level of the determination target becomes the maximum is given to the user. As another example thereof, there is a configuration in which an in-game element obtained by evolving the determination target is given to the user.

Each of the plurality of terminals 20, and 201 to 20N is managed by the user (or a player) who plays the video game, and is configured by a communication terminal, such as a cellular phone terminal, a PDA (Personal Digital Assistants), or a mobile game device, by which the user can play a network delivery type video game, for example. In this regard, a configuration of the terminal that the system 100 can include is not limited to the examples described above. It may be a configuration in which the user can recognize the video game. As other examples of the configuration of the terminal, there are a so-called wearable divide such as a smartwatch, and a combination of the wearable divide and the communication terminal.

Further, each of the plurality of terminals 20, and 201 to 20N is connected to the communication network 30, and includes hardware (for example, a display device for displaying a game screen, an audio output device and the like) and software for executing the video game by communicating with the server 10. In this regard, each of the plurality of terminals 20, and 201 to 20N may be configured so as to be capable of directly communicating with each other without the server 10. Further, each of the plurality of terminals 20, and 201 to 20N outputs an image of the video game to its own display device on the basis of information transmitted from the server 10 (for example, information regarding a game image).

Next, an operation of the system 100 according to the present embodiment will be described.

FIG. 3 is a flowchart illustrating an example of game related processing executed by the system 100. Hereinafter, a case where the server 10A and the terminal 20 execute transmission and reception of information regarding the video game will be described as an example. Further, a case where a user U who currently plays a video game A played the other video game B in the past will be described as an example. In this regard, the game related processing according to the present embodiment is executed in a case where predetermined timing when a determination target is specified comes, for example.

In the game related processing, the server 10A first specifies a determination target (Step S11). In the present embodiment, the server 10A specifies, as the determination target, an in-game element X1 that appears in the video game A.

The server 10A refers to a predetermined storage region to determine whether the determination target corresponds to a given element or not (Step S12). In the present embodiment, the server 10A refers to a storage unit for storing information regarding the given element, and determines whether the in-game element X1 corresponds to an in-game element given in the other video game B. In this regard, the server 10A terminates the processing herein in a case where it is determined that the determination target does not correspond to the given element.

In a case where it is determined that the determination target corresponds to the given element, the server 10A gives the given target to the user U (Step S13). In the present embodiment, in a case where it is determined that an in-game element X2 of the given element corresponds to the in-game element X1, the server 10A specifies, as the given target, the in-game element X2 (or an in-game element X2′ that is regarded as the same as the in-game element X2 in the video game A), and associates it with the user U. Further, the server 10A updates user information, and transmits information regarding the in-game element X2 (or the in-game element X2′) to the terminal 20. This causes the system 100 to give the user the given target. When the given target is given to the user, the system 100 terminates the processing herein.

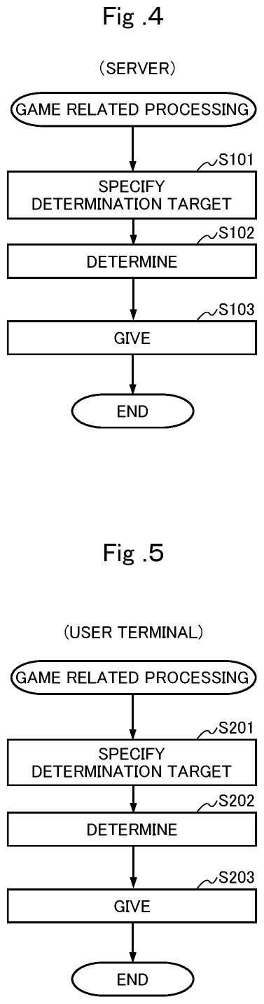

FIG. 4 is a flowchart illustrating an example of an operation of the server 10A side in the game related processing. Here, an operation of the server 10A in the system 100 will be described again.

In the game related processing, the server 10A first specifies a determination target (Step S101); refers to a predetermined storage region to determine whether the determination target corresponds to a given element or not (Step S102); give a user the given target in a case where it is determined that the determination target corresponds to the given element (Step S103); and terminates the processing herein.

FIG. 5 is a flowchart illustrating an example of an operation of the terminal 20 in a case where the terminal 20 executes the game related processing. Hereinafter, the case where the terminal 20 executes the game related processing by a single body will be described as an example. In this regard, the terminal 20 is configured to include similar functions to the configuration of the server 10A. For this reason, its description is omitted from a point of view to avoid repeated explanation.

In the game related processing, the terminal 20 first specifies a determination target (Step S201); refers to a predetermined storage region to determine whether the determination target corresponds to a given element or not (Step S202); give a user the given target in a case where it is determined that the determination target corresponds to the given element (Step S203); and terminates the processing herein.

As explained above, as one side of the first embodiment, the system 100 is configured so as to include the specifying unit 11, the determining unit 12, and the giving unit 13. Thus, the specifying unit 11 specifies at least one in-game element as the determination target on the basis of progress of the video game; the determining unit 12 refers to the predetermined storage region in which the information regarding the given element is stored to determine whether the determination target corresponds to the given element or not; and gives the user the given target in a case where it is determined that the determination target corresponds to the given element. Therefore, it is possible to improve the taste of the other video game by using the game information of the one video game.

Namely, for example, a user who starts a new video game cannot obtain incentive based on progress of the other video game (that is, the “given target” according to the embodiment described above) until the user obtains something obtained in the other video game (or something that corresponds to the one obtained in the other video game). For that reason, in this video game, the user has motive for obtaining something obtained in the other video game. This may also occur in a case where the user plays a plurality of video games in parallel. Therefore, by the embodiment described above, it is possible to provide the user with motive for continuously playing the other video game by using the game information of the one video game.

(Second Embodiment)

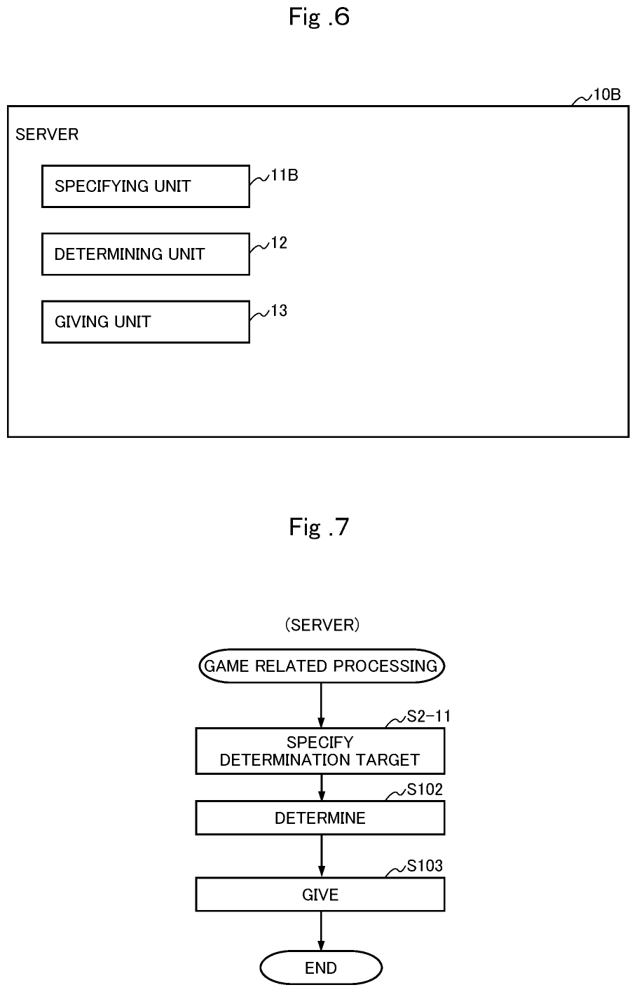

FIG. 6 is a block diagram illustrating a configuration of a server 10B, which is an example of the server 10. In the present embodiment, the server 10B at least includes a specifying unit 11B (which corresponds to one example of a specifying function), a determining unit 12, and a giving unit 13.

The specifying unit 11B has a function to execute a process for specifying, in a case where an event of a video game is executed on the basis of a request from a user, an in-game element, for which an acquisition condition is satisfied in the event, as a determination target. Here, the event means an event or occurrence that can occur in the video game. A configuration for executing an event is not limited particularly. However, it is preferable that it is a configuration in which the user operates an object, whereby the event proceeds. As an example of such a configuration, there is a configuration in which success determination is executed in response to a user operation on the basis of whether a predetermined task provided in an event is achieved or not. A so-called quest and a battle are included in examples of the event. Further, as examples of the task, there are arrival to a predetermined position and defeat of an enemy character. Further, the phrase “an acquisition condition is satisfied” means that a condition defined in advance for acquiring an in-game element is satisfied or met. A configuration that the acquisition condition is satisfied is not limited particularly. However, it is preferable that a task is achieved, or an enemy character is defeated (or the user wins in a lottery arising from the defeat). As examples of the in-game element for which an acquisition condition is satisfied in the event, there are a quest reward and a drop reward.

FIG. 7 is a flowchart illustrating an example of game related processing executed by the system 100. Hereinafter, an operation of the server 10B side will be described as an example. In this regard, explanation for a case where the terminal 20 (that is, the terminal 20 that includes similar functions to the configuration of the server 10B) executes the game related processing by a single body, and portions that have already been explained are omitted from a point of view to avoid repeated explanation.

In a case where an event in the video game is executed on the basis of a request from the user, the specifying unit 11B specifies an in-game element for which an acquisition condition is satisfied in the event as a determination target (Step S2-11).

As explained above, as one side of the second embodiment, the system 100 is configured so as to at least include the specifying unit 11B, the determining unit 12, and the giving unit 13. Thus, in a case where the event in the video game is executed on the basis of the request from the user, the specifying unit 11B specifies the in-game element for which the acquisition condition is satisfied in the event as a determination target. Therefore, it is possible to provide the user with motive for causing the other video game to continuously proceed by using game information of one video game.

Namely, for example, a user who starts a new video game cannot obtain incentive based on progress of the other video game (that is, the “given target” according to the embodiment described above) until the user obtains something obtained in the other video game (or something that corresponds to the one obtained in the other video game). For that reason, in this video game, the user has motive for obtaining something obtained in the other video game. This may also occur in a case where the user plays a plurality of video games in parallel. Therefore, by the embodiment described above, it is possible to provide the user with motive for continuously playing the other video game by using the game information of the one video game.

(Third Embodiment)

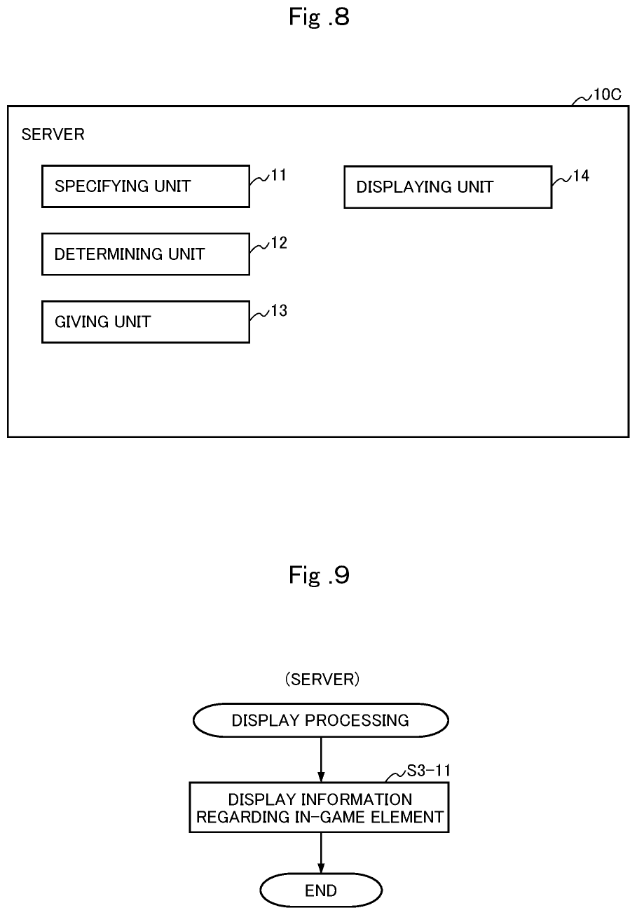

FIG. 8 is a block diagram illustrating a configuration of a server 10C, which is an example of the server 10. In the present embodiment, the server 10C at least includes a specifying unit 11, a determining unit 12, a giving unit 13, and a displaying unit 14 (which corresponds to one example of a displaying function).

The displaying unit 14 has a function to execute a process for referring to a predetermined storage region to display information regarding an in-game element that corresponds to a given element among a plurality of in-game elements that appears in a video game. Here, a configuration regarding timing when the information is displayed is not limited particularly. As an example of the configuration regarding the timing when the information is displayed, there is a configuration in which timing when a request to display information is received from a user is set as timing when the information is displayed. Further, the phrase “display information” means that each of user terminals 20, and 201 to 20N is caused to output an image on a display device included therein by means of communication using a communication network 30. As an example of the configuration to display information, there is a configuration in which information generated by the server 10C (image information) is transmitted to each of the user terminals 20, and 201 to 20N. In this regard, a configuration of the image information is not limited particularly. For example, the image information may be information obtained by compressing an image, or information for causing each of the user terminals 20, and 201 to 20N to generate an image. As an example of the information obtained by compressing an image, there is one used in a cloud game (for example, MPEG). Further, as an example of the information for causing each of the user terminals 20, and 201 to 20N to generate an image, there is one used in an online game (for example, positional information).

FIG. 9 is a flowchart illustrating an example of display processing executed by a system 100. Hereinafter, an operation of the server 10C side will be described as an example. In this regard, explanation for a case where the terminal 20 (that is, the terminal 20 that includes similar functions to the configuration of the server 10C) executes the display processing by a single body, and portions that have already been explained are omitted from a point of view to avoid repeated explanation. In this regard, the display processing according to the present embodiment is executed in a case where predetermined timing for executing the display processing comes, for example.

In the display processing, the server 10C displays information regarding an in-game element that corresponds to a given element among a plurality of in-game elements that appears in a video game (Step S3-11), and terminates the processing herein.

As explained above, as one side of the third embodiment, the system 100 is configured so as to at least include the specifying unit 11, the determining unit 12, the giving unit 13, and the displaying unit 14. Thus, the displaying unit 14 refers to the predetermined storage region to display the information regarding the in-game element that corresponds to the given element among the plurality of in-game elements that appears in the video game. Therefore, it is possible to cause the user to recognize what kind of determination target is to be acquired, and to provide the user with motive for acquiring an in-game element that leads to incentive. This makes it possible to provide the user with motive for continuously playing the other video game by using game information of one video game.

(Fourth Embodiment)

A system according to the present embodiment relates to a system that allows a user to use game information of the other video game that the user plays (or played) (hereinafter, referred to as an “old game”) in a video game that the user currently plays (hereinafter, referred to as a “new game”). A kind of game information to be used and a utilization form of the game information are not limited particularly. As examples of the kind of game information, there are information regarding an item that was given (including information regarding an item that has been given in the past and information regarding an obtaining item), information regarding an advanced story, information regarding a charged item, and information regarding in-game currency. As examples of the utilization form of the game information, there are a situation where part of the game information is used in the new game as it is, and a situation where a privilege that corresponds to the game information is given to the user. Here, a case where information regarding an item obtained in an old game is used in a new game will be described as an example.

In particular, the old game according to the present embodiment is a video game that adopts an online type video game system via a server (that is, a so-called social game). Further, the new game according to the present embodiment is a video game that adopts a video game system that operates by a single body without depending upon the other equipment (that is, a so-called stand-alone type). In this regard, the new game may be configured by a client-server type video game system as described in the above embodiment.

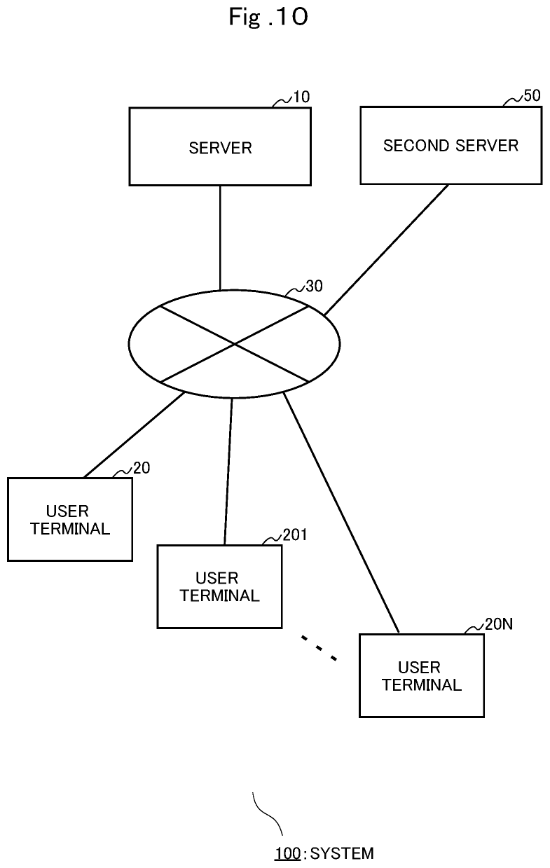

FIG. 10 is a block diagram illustrating an example of a configuration of a system 100 according to one embodiment of the present invention. As illustrated in FIG. 10, the system 100 includes user terminals 20, and 201 to 20N (“N” is an arbitrary integer. Hereinafter, they are simply referred to as “terminals 20, and 201 to 20N”.), a server 10, and a second server 50 that is different from the server 10. In this regard, a configuration of the system 100 is not limited to this. The system 100 may be configured so that a plurality of users uses a single terminal. In this regard, in each of the embodiments described above, the case where the server 10 mainly executes various kinds of processes has been described. However, in the present embodiment, a case where the terminal 20 executes the various kinds of processes will be described.

The second server 50 is a server for controlling progress of the old game, and has various kinds of functions to provide information regarding various kinds of processes to each of the plurality of terminals 20, and 201 to 20N. In the present embodiment, the second server 50 is constructed by an information processing apparatus such as a WWW server, and includes a storage medium for storing various kinds of information. At least information regarding a given element is stored in the storage medium. In this regard, the second server 50 may be provided with a storage region in an accessible state. For example, the system 100 may be configured so as to be provided with the storage region on the outside thereof.

Each of the plurality of terminals 20, and 201 to 20N is managed by the user (or a player) who plays the video game, and is configured by a communication terminal, such as a cellular phone terminal, a PDA (Personal Digital Assistants), or a mobile game device, by which the user can play a network delivery type video game, for example. In this regard, a configuration of the terminal that the system 100 can include is not limited to the examples described above. It may be a configuration in which the user can recognize the video game. As other examples of the configuration of the terminal, there are a so-called wearable divide such as a smartwatch, and a combination of the wearable divide and the communication terminal.

Further, each of the plurality of terminals 20, and 201 to 20N is connected to the communication network 30, and includes hardware (for example, a display device for displaying a game screen, an audio output device and the like) and software for executing the video game by communicating with the server 10. In this regard, each of the plurality of terminals 20, and 201 to 20N may be configured so as to be capable of directly communicating with each other without the server 10. Further, each of the plurality of terminals 20, and 201 to 20N outputs an image of the video game to its own display device on the basis of information transmitted from the server 10 (for example, information regarding a game image).

Here, software included in each of the plurality of terminals 20, and 201 to 20N contains an application program for executing each video game. As examples of the application program for executing each video game, there are an application program for executing the new game, and an application program regarding an application program for executing the old game.

In this regard, the system 100 may be configured so that a function, which can normally be executed by the application program for executing the old game, is restricted when predetermined timing comes. Here, the predetermined timing means timing that is defined by an administrator of a system for the old game. As an example of the predetermined timing, there is timing to take over game information to the new game. Further, the function that can normally be executed means a function that becomes executable before predetermined timing. As an example of the function that can normally be executed, there is a function to start a quest. Further, a function that can be executed after the function is restricted is not limited particularly. However, it is preferable that the function is a function for being associated with a process to be executed in the new game. As examples of the function can be executed after the function is restricted, there are a function to generate and update the information regarding the given element, a function to receive a request to transmit the information regarding the given element, and a function to transmit the information regarding the given element to a terminal. In this regard, a configuration to realize restriction of the function may be configured so as to be realized by restricting the function of the second server 50 itself.

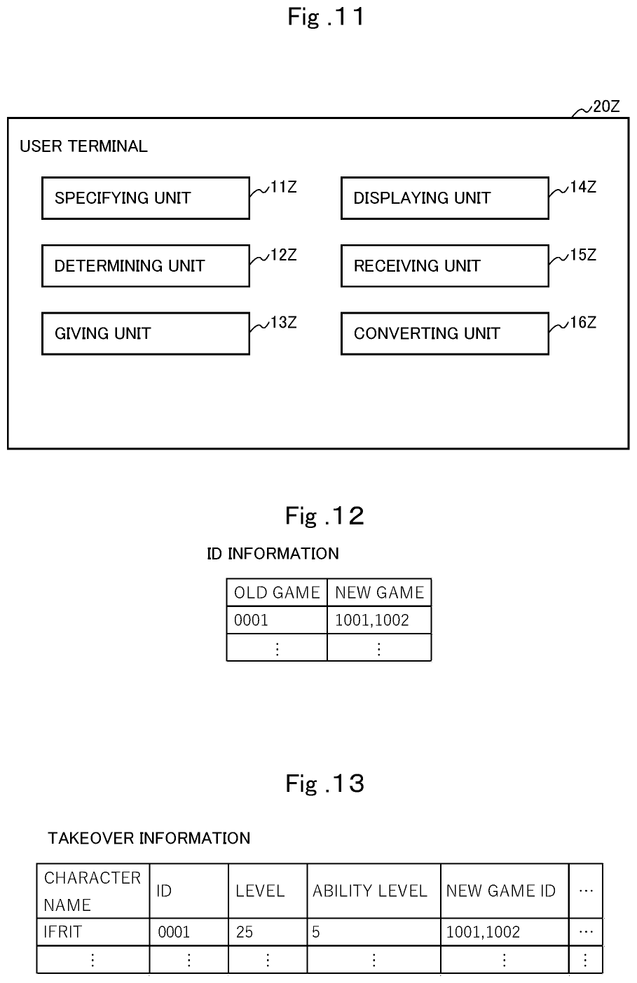

FIG. 11 is a block diagram illustrating a configuration of a terminal 20Z, which is an example of the terminal 20. In the present embodiment, the terminal 20Z at least includes a specifying unit 11Z (which corresponds to one example of a specifying function), a determining unit 12Z (which corresponds to one example of a determining function), a giving unit 13Z (which corresponds to one example of a giving function) , a displaying unit 14Z (which corresponds to one example of a displaying function), a receiving unit 15Z, and a converting unit 16Z.

The specifying unit 11Z has a function to execute a process for specifying at least one in-game element as a determination target on the basis of progress of the new game. Moreover, the specifying unit 11Z also has a function to execute a process for specifying, in a case where an event in the new game is executed on the basis of a request from the user, an in-game element for which an acquisition condition is satisfied in the event as a determination target.

The determining unit 12Z has a function to execute a process for referring to a predetermined storage region to determine whether the determination target corresponds to an in-game element that was given to the user in the old game (hereinafter, referred to as a “given element”) or not.

Further, the determining unit 12Z may be configured to determine whether the determination target is an in-game element using the given element or not. Here, the phrase “using” means that the in-game element becomes a basis thereof. As examples of the in-game element using the given element, there are an in-game element in which a character name is the same as the given element, an in-game element in which ability is the same as the given element, and an in-game element in which illustration thereof is the same as the given element. A configuration to determine whether the determination target is the in-game element using the given element or not is not limited particularly. However, it is preferable that it is configured to refer to a storage region in which the information regarding the given element and information regarding the determination target are stored, compare the information regarding the given element with the information regarding the determination target, and determine whether the same portion is contained therein or not.

The giving unit 13Z has a function to execute a process for giving the user the given target in a case where it is determined that the determination target corresponds to the given element. Further, the giving unit 13Z also has a function to execute a process for giving the user the determination target in a case where it is determined that the determination target does not correspond to the given element. In this regard, the giving unit 13Z may be configured so as to give the user the given target and the determination target in a case where it is determined that the determination target corresponds to the given element.

Further, the giving unit 13Z may be configured so as to give the user an in-game element having a predetermined relationship with the determination target as at least a part of the given target. Here, a configuration to specify the in-game element having a predetermined relationship with the determination target is not limited particularly. However, it is preferable that it is a configuration to store information for specifying the in-game element having the predetermined relationship in a predetermined storage region, and specify the in-game element having the predetermined relationship with the determination target by referring to the information. Further, it is preferable that the user can recognize which in-game element has a predetermined relationship with a determination target as the in-game element having the predetermined relationship with the determination target. As examples of the predetermined relationship, there are a relationship corresponding after evolution, a relationship corresponding before evolution, and a relationship that series are the same. Namely, as examples of the in-game element having the predetermined relationship with the determination target, there are an in-game element obtained by evolving a determination target, an in-game element before evolution of a determination target, and an in-game element whose series are the same as that of a determination target.

The displaying unit 14Z has a function to execute a process for referring to a predetermined storage region to display the information regarding the given element. Moreover, the displaying unit 14Z has a function to execute a process for displaying information indicating an in-game element that corresponds to the given element among in-game elements that appear in the new game. Moreover, the displaying unit 14Z may be configured so as to display, with a predetermined display mode, an in-game element that has not been given to the user in the new game yet among information indicating in-game elements that corresponds to the given element. A configuration regarding timing to display the information is not limited particularly. However, it is preferable to display the information in a case where predetermined informing timing comes. As an example of the configuration to display the information, there is a configuration in which the information is displayed in a case where a browsing request for the given element is received from the user. As another example thereof, there is a configuration in which information for informing the user that an “in-game element that correspond to an unobtained given element” can be obtained by clearing a task is displayed in a case where a task selecting screen is displayed. Moreover, as another example thereof, there is a configuration in which information for informing the user that an “in-game element that corresponds to an unobtained given element” can be obtained as a drop reward by defeating an enemy character that appears in a quest is displayed in a case where a quest selecting screen is displayed.

The receiving unit 15Z has a function to execute a process for receiving various kinds of information. The phrase “receive various kinds of information” means that information transmitted from a predetermined transmission destination is received. A configuration to receive various kinds of information is not limited particularly. However, it is preferable that the configuration is a configuration in which a transmission request is carried out against a predetermined server and information is received from the predetermined server that received the transmission request. As an example of the configuration to receive various kinds of information, there is a configuration in which information regarding a given element is received from the second server 50.

The converting unit 16Z has a function to execute a process for converting various kinds of information. The phrase “convert various kinds of information” means that predetermined information is converted into another information in accordance with a predetermined conversion rule. A configuration to convert various kinds of information is not limited particularly. However, there is a configuration in which the predetermined conversion rule is stored in a storage region, and information received by the receiving unit 15Z is converted into information that can be referred to in the application program for executing the new game. As an example of the configuration to convert various kinds of information, there is a configuration in which the information regarding the given element received from the second server 50 is converted into information in which part of the information is contained (hereinafter, referred to as “takeover information”). The terminal 20Z stores the converted takeover information in a storage unit (not illustrated in the drawings).

FIG. 12 is an explanatory drawing for explaining an example of a storage state of information stored in a storage unit (not illustrated in the drawings) included in the terminal 20Z. As illustrated in FIG. 12, the terminal 20Z stores ID information therein. The ID information is information for specifying a relationship between identification information (ID) of an in-game element that appears in the old game and identification information (ID) of an in-game element that appears in the new game. In the example illustrated in FIG. 12, an ID of a stored item in the old game provided in a left column is associated with an ID of a stored item in the new game provided in a right column. For example, an item whose ID is 0001 is associated with an item whose ID is 1001 and an item whose ID is 1002. It may be configured so that the IDs to be associated overlap. The converting unit 16Z refers to the ID information to associate the ID that corresponds to the new game with each item contained in the information regarding the given element, thereby converting the information regarding the given element.

FIG. 13 is an explanatory drawing for explaining an example of a storage state of information stored in the storage unit (not illustrated in the drawings) included in the terminal 20Z. As illustrated in FIG. 13, the terminal 20Z stores the takeover information therein. The takeover information is information that contains at least part of the information regarding the in-game element given to the user in the old game. In the example illustrated in FIG. 13, a character name, a character ID, a level, a level of ability, and an ID of an item in the corresponding new game for each item given in the old game are associated with each other.

Next, an operation of the system 100 according to the present embodiment will be described. First, takeover processing executed by the system 100 will be described.

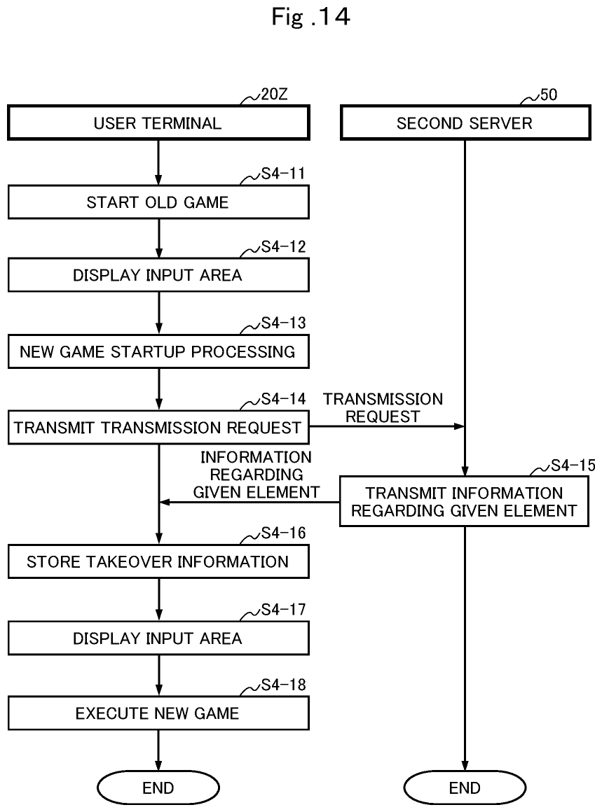

FIG. 14 is a flowchart illustrating an example of the takeover processing executed by the system 100. Hereinafter, operations of the terminal 20Z and the second server 50 will be described as an example. In this regard, a case where an application program for executing an old game and an application program for executing a new game are installed in the terminal 20Z will be described as an example of the takeover processing according to the present embodiment, for example.

In the game related processing, the terminal 20Z first receives a user input for starting the application program of the old game, and cause the old game to start (Step S4-11).

Subsequently, when the old game is started, the terminal 20Z displays an input area for starting the new game on a game screen of the old game (Step S4-12). For example, the terminal 20Z displays, by an icon, the input area for starting the new game.

When a user input for starting the new game is received, the terminal 20Z executes a process to start the new game (Step S4-13). For example, the terminal 20Z causes the new game to start by using a URL scheme.

Moreover, when the user input for starting the new game is received, the terminal 20Z transmits, to the second server 50, a request to transmit information regarding a given element (Step S4-14). For example, the terminal 20Z transmits, to the second server 50, a transmission request in which a user ID associated with the terminal 20Z in advance is presented.

When the transmission request is received, the second server 50 transmits the information regarding the given element to the terminal 20Z (Step S4-15). For example, the second server 50 may be configured to store information regarding an in-game element given to a user of the terminal 20Z in the old game in advance and the user ID associated with the terminal 20Z in advance so as to be associated with each other.

When the information regarding the given element is received from the second server 50, the terminal 20Z converts it into information that can be referred to in the application program for executing the new game, and stores the converted information as takeover information (Step S4-16). For example, the terminal 20Z stores a predetermined conversion rule in advance, and converts the information regarding the given element in accordance with the predetermined conversion rule to store the converted one as the takeover information. In this regard, timing when the takeover information is stored is not limited particularly. However, it is preferable that the takeover information is stored before game progress of the new game is started.

When the takeover information is stored, the terminal 20Z displays, on a game screen of the new game, an input area for executing the new game by using the takeover information (Step S4-17).

When a user input for executing the new game is received, the terminal 20Z executes the new game using the takeover information in accordance with the application program for executing the new game (Step S4-18), and terminates the processing herein.

Next, game related processing executed by the system 100 will be described.

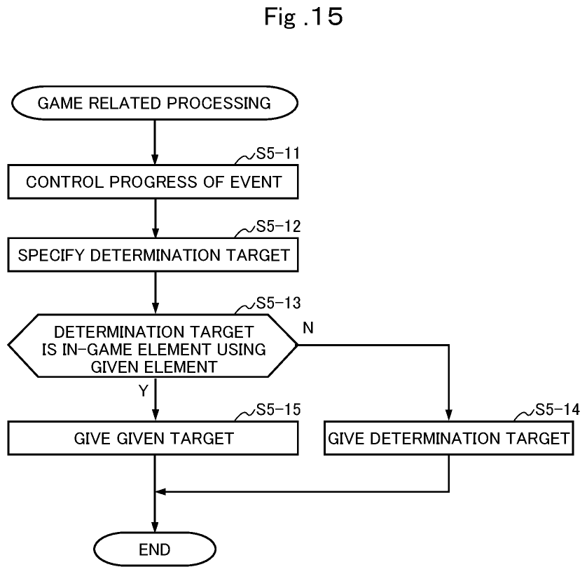

FIG. 15 is a flowchart illustrating an example of the game related processing executed by the system 100. Hereinafter, an operation of the terminal 20Z will be described as an example.

In the game related processing, the terminal 20 first controls progress of a game event on the basis of a predetermined input (Step S5-11). For example, the terminal 20Z receives a request and a user input from a user, and controls progress of a defeat event against an enemy character.

The terminal 20Z specifies, as a determination target, an in-game element for which an acquisition condition is satisfied in the event (Step S5-12). The system 100 may be configured so as to terminate the processing herein in a case where there is no in-game element for which the acquisition condition is satisfied in the event.

When the determination target is specified, the terminal 20Z refers to a storage region by which an ID of the determination target can be specified and a storage region in which takeover information is stored, and determines whether the determination target corresponds to the given element or not (Step S5-13). For example, the terminal 20Z determines whether the determination target is an in-game element using the given element or not. Specifically, the terminal 20Z refers to the ID of the determination target and the takeover information to determine whether the determination target corresponds to the given element or not.

In a case where it is determined that the determination target does not correspond to the given element (“N” at Step S5-13), the terminal 20Z gives the user the determination target (Step S5-14), and terminates the processing herein.

On the other hand, in a case where it is determined that the determination target corresponds to the given element (“Y” at Step S5-13), the terminal 20Z specifies a given target, gives the user it (Step S5-15), and terminates the processing herein.

Next, display processing executed by the system 100 will be described.

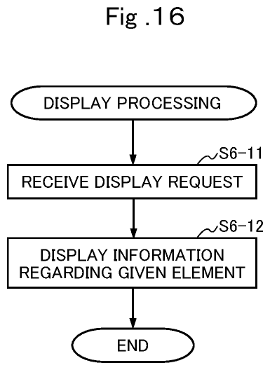

FIG. 16 is a flowchart illustrating an example of the display processing executed by the system 100. Hereinafter, an operation of the terminal 20Z will be described as an example.

In the display processing, the terminal 20Z first receives a display request from the user (Step S6-11). For example, the terminal 20Z receives a display request for information regarding a given element among in-game elements that appear in the new game. As another example thereof, the terminal 20Z receives a display request for a quest list screen.

When the display request is received, the terminal 20Z refers to the display request and takeover information to display the information regarding the given element (Step S6-12), and terminates the processing herein. For example, the terminal 20Z displays the information on the given element. As another example thereof, the terminal 20Z displays information indicating an in-game element that corresponds to the given element among the in-game elements that appear in the new game. As still another example thereof, the terminal 20Z displays an in-game element that has not been given to the user in the new game yet in the information indicating the in-game element that corresponds to the given element so as to be highlighted. As still another example thereof, the terminal 20Z displays, on the quest list screen, an in-game element that corresponds to an acquirable given element.

As explained above, as one side of the fourth embodiment, the system 100 is configured so as to include the specifying unit 11Z, the determining unit 12Z, and the giving unit 13Z. Thus, specifying unit 11Z specifies the determination target on the basis of progress of the new game; the determining unit 12Z refers to the predetermined storage region in which the information regarding the given element is stored to determine whether the determination target corresponds to the given element or not; and the giving unit 13Z gives the user the given target in a case where it is determined that the determination target corresponds to the given element. Therefore, it is possible to improve the taste of the new game by using the game information of the old game.

Namely, for example, a user who starts a new game cannot obtain incentive based on progress of the old game (that is, the “given target” according to the embodiment described above) until the user obtains something obtained in the old game (or something that corresponds to the one obtained in the old game). For that reason, in the new game, the user has motive for obtaining something obtained in the old game. This may also occur in a case where the user plays a plurality of video games in parallel. Therefore, by the embodiment described above, it is possible to provide the user with motive for continuously playing the new game by using the game information of the old game.

Further, as one side of the fourth embodiment, the system 100 is configured so as to at least include the specifying unit 11Z, the determining unit 12Z, and the giving unit 13Z. Thus, in a case where the event in the new game is executed on the basis of the request from the user, the specifying unit 11Z specifies, as the determination target, the in-game element for which the acquisition condition is satisfied in the event. Therefore, it is possible to provide the user with motive for causing the new game to continuously proceed by using the game information of the old game.

Namely, for example, a user who starts a new game cannot obtain incentive based on progress of the old game (that is, the “given target” according to the embodiment described above) until the user obtains something obtained in the old game (or something that corresponds to the one obtained in the old game). For that reason, in the new game, the user has motive for obtaining something obtained in the old game. This may also occur in a case where the user plays a plurality of video games in parallel. Therefore, by the embodiment described above, it is possible to provide the user with motive for continuously playing the new game by using the game information of the old game.

Further, as one side of the fourth embodiment, the system 100 is configured so as to at least include the specifying unit 11Z, the determining unit 12Z, the giving unit 13Z, and the displaying unit 14Z. Thus, the displaying unit 14Z refers to the predetermined storage region to display the information regarding the given element among a plurality of in-game elements that appears in the new game. Therefore, it is possible to cause the user to recognize what kind of determination target is to be acquired, and to provide the user with motive for acquiring an in-game element that leads to incentive. This makes it possible to provide the user with motive for continuously playing the new game by using the game information of the old game.

In this regard, as mentioned in the embodiment described above, the terminal 20Z may be configured so as to display the information on the given element. Further, the terminal 20Z may be configured so as to display the information indicating the in-game element that corresponds to the given element among the in-game elements that appear in the new game. Further, the terminal 20Z may be configured so as to display the in-game element that has not been given to the user in the new game yet in the information indicating the in-game element that corresponds to the given element so as to be highlighted. Further, the terminal 20Z may be configured so as to display, on the quest list screen, the in-game element that corresponds to the acquirable given element.

Further, as mentioned in the embodiment described above, the system 100 may be configured so as to give the in-game element that has the predetermined relationship with the determination target as at least part of the given target. According to such a configuration, by increasing the incentive, user's motivation to continue the game can be heightened. This makes it possible to improve the taste of the new game by using the game information of the old game.

In this regard, it has not been mentioned particularly in the embodiments. However, the system 100 maybe configured so as to: determine whether there is a given element whose appearance is related to the determination target or not; specify an in-game element that corresponds to the given element with the related appearance in a case where there is the given element whose appearance is related to the determination target; and give the user the specified in-game element. Further, in this case, the system 100 may further be configured so as to: determine whether there is a given element that has a predetermined relationship defined by an administrator of the system 100 in advance (for example, whether there is a “hidden element whose appearance is completely different therefrom” or not) in a case where it is determined that it is not the given element whose appearance is related to the determination target; specify an in-game element that corresponds to the given element with the predetermined relationship in a case where there is the given element that has the predetermined relationship; and give the user the specified in-game element.

The converting unit 16Z is configured so as to convert the information regarding the given element into the takeover information with which the ID of the item in the new game is associated on the basis of the ID information. However, it is not limited to such a configuration. For example, the terminal 20Z may be configured so as to: convert the information regarding the given element into a utilizable form in the application for the new game to store it in the storage unit (or store the information regarding the given element in the storage unit as it is); and refer to the ID information to determine whether to correspond to the given element or not when whether to correspond to the given element is to be determined.

In this regard, in the embodiment described above, the converting unit 16Z is configured so as to convert the information regarding the given element into the takeover information with which the ID of the item in the new game is associated on the basis of the ID information. However, it is not limited to such a configuration. For example, the terminal 20Z maybe configured so as to: convert the information regarding the given element into a utilizable form in the application for the new game to store it in the storage unit (or store the information regarding the given element in the storage unit as it is); and refer to the ID information to determine whether to correspond to the given element or not when whether to correspond to the given element is to be determined.

As explained above, one or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, 201 to 20N and the server 10 carries out the various kinds of processing described above in accordance with various kinds of control programs (for example, a program) stored in the storage device with which the corresponding terminal or server is provided. A control unit (not illustrated in the drawings particularly) may be configured so as to include a specifying unit 11, a determining unit 12, a giving unit 13, a displaying unit 14, a receiving unit 15, and a converting unit 16, and have functions to execute processes that are respectively to be executed by the units 11Z to 16Z.

Further, the configuration of the system 100 is not limited to the configuration that has been explained as an example of each of the embodiments described above. For example, the system 100 may be configured so that the server 10 carries out a part or all of the processes that have been explained as the processes carried out by the user terminal. Alternatively, the system 100 may be configured so that any of the plurality of user terminals 20, 201 to 20N (for example, the user terminal 20) carries out a part or all of the processes that have been explained as the processes carried out by the server 10. Further, the system 100 may be configured so that a part or all of the storing sections included in the server 10 is included in any of the plurality of user terminals 20, 201 to 20N. Namely, the system 100 may be configured so that a part or all of the functions of any one of the user terminal 20 and the server 10 according to the system 100 is included in the other.

(Appendix)

The explanation of the embodiments described above has been described so that the following inventions can be at least realized by a person having a normal skill in the art to which the present invention belongs.

(1)

A program for causing a user terminal to realize functions to control progress of a video game,
wherein the functions include:
a specifying function configured to specify at least one in-game element as a determination target on a basis of progress of the video game;
a determining function configured to refer to a predetermined storage region in which information regarding an in-game element that has been given to a user in the other video game (hereinafter, referred to as a “given element”) is stored, and determine whether the determination target corresponds to the given element or not; and
a giving function configured to give the user an in-game element different from the determination target (hereinafter, referred to as a “given target”) in a case where it is determined that the determination target corresponds to the given element.
   (2)

The program according to (1),
wherein the specifying function includes a function configured to specify, in a case where an event of the video game is executed on a basis of a request from the user, an in-game element, for which an acquisition condition is satisfied in the event, as the determination target.
   (3)

The program according to (1) or (2),
wherein the functions further include:
a displaying function configured to refer to the predetermined storage region to display information regarding an in-game element that corresponds to the given element among a plurality of in-game elements that appears in the video game.
   (4)

The program according to any one of (1) to (3),
wherein the giving function includes a function configured to give, as at least a part of the given target, an in-game element that has a predetermined relationship with the determination target.
   (5)

The program according to any one of (1) to (4),
wherein the functions further include:
a function configured to refer to the predetermined storage region to display information regarding an in-game element among the in-game elements that appear in the video game, the in-game element being an in-game element that has not been given to the user in the video game yet and corresponding to the given element.
   (6)

The program according to any one of (1) to (5),
wherein the determining function includes a function configured to determine whether the determination target is an in-game element using the given element or not.
   (7)

The program according to any one of (1) to (6),
wherein the other video game is executed by another program different from the program by which the video game is executed.
   (8)

The program according to any one of (1) to (7),
wherein information containing at least part of the information regarding the in-game element that has been given to the user in the other video game (hereinafter, referred to as “takeover information”) is stored in the storage region.
   (9)

The program according to any one of (1) to (8),
wherein the giving function includes a function configured to give the user the determination target in a case where it is determined that the determination target does not correspond to the given element.
   (10)

A program for causing a server to realize at least one function of the functions that the program described in any one of (1) to (9) causes the user terminal to realize, the server being capable of communicating with the user terminal.

(11)

A user terminal into which the program described in any one of (1) to (10) is installed.

(12)

A system for controlling progress of a video game, the system comprising a communication network, a server, and a user terminal, the system comprising:
a specifying unit configured to specify at least one in-game element as a determination target on a basis of progress of the video game;
a determining unit configured to refer to a predetermined storage region in which information regarding an in-game element that has been given to a user in the other video game (hereinafter, referred to as a “given element”) is stored, and determine whether the determination target corresponds to the given element or not; and
a giving unit configured to give the user an in-game element different from the determination target (hereinafter, referred to as a “given target”) in a case where it is determined that the determination target corresponds to the given element.
   (13)

The system according to (12),
wherein the server includes the specifying unit, the determining unit, and the giving unit, and
wherein the user terminal includes:
a displaying unit configured to output a game image to a display screen of a display device on a basis of image information for displaying the game image, the game image indicating progress of the video game transmitted from the server.
   (14)

A program for causing a server to realize functions to control progress of a video game,
wherein the server includes:
a specifying function configured to specify at least one in-game element as a determination target on a basis of progress of the video game;
a determining function configured to refer to a predetermined storage region in which information regarding an in-game element that has been given to a user in the other video game (hereinafter, referred to as a “given element”) is stored, and determine whether the determination target corresponds to the given element or not; and
a giving function configured to give the user an in-game element different from the determination target (hereinafter, referred to as a “given target”) in a case where it is determined that the determination target corresponds to the given element,
wherein the program causes a user terminal to realize an outputting function configured to output a game image to a display screen of a display device on a basis of information for displaying the game image, the game image indicating progress of the video game transmitted from the server.
   (15)

A program for causing a server to realize functions to control progress of a video game,
wherein the functions include:
a specifying function configured to specify at least one in-game element as a determination target on a basis of progress of the video game;
a determining function configured to refer to a predetermined storage region in which information regarding an in-game element that has been given to a user in the other video game (hereinafter, referred to as a “given element”) is stored, and determine whether the determination target corresponds to the given element or not; and
a giving function configured to give the user an in-game element different from the determination target (hereinafter, referred to as a “given target”) in a case where it is determined that the determination target corresponds to the given element.
   (16)

A method of controlling progress of a video game, the method comprising:
a specifying process of specifying at least one in-game element as a determination target on a basis of progress of the video game;
a determining process of referring to a predetermined storage region in which information regarding an in-game element that has been given to a user in the other video game (hereinafter, referred to as a “given element”) is stored, and determining whether the determination target corresponds to the given element or not; and
a giving process of giving the user an in-game element different from the determination target (hereinafter, referred to as a “given target”) in a case where it is determined that the determination target corresponds to the given element.
   (17)

A method of controlling progress of a video game by a system, the system comprising a communication network, a server, and a user terminal, the method comprising:
a specifying process of specifying at least one in-game element as a determination target on a basis of progress of the video game;
a determining process of referring to a predetermined storage region in which information regarding an in-game element that has been given to a user in the other video game (hereinafter, referred to as a “given element”) is stored, and determining whether the determination target corresponds to the given element or not; and
a giving process of giving the user an in-game element different from the determination target (hereinafter, referred to as a “given target”) in a case where it is determined that the determination target corresponds to the given element.

### INDUSTRIAL APPLICABILITY

According to one of the embodiments of the present invention, it is useful for a video game using game information of a different video game.

### EXPLANATION OF REFERENCE NUMERALS

10 server
11 specifying unit
12 determining unit
13 giving unit
14 displaying unit
15 receiving unit
16 converting unit
20, 201 to 20N user terminal
30 communication network
50 second server
100 system

1. A program for causing a user terminal to realize functions to control progress of a video game,
wherein the functions include:
a specifying function configured to specify at least one in-game element as a determination target on a basis of progress of the video game;
a determining function configured to refer to a predetermined storage region in which information regarding an in-game element that has been given to a user in the other video game (hereinafter, referred to as a “given element”) is stored, and determine whether the determination target corresponds to the given element or not; and
a giving function configured to give the user an in-game element different from the determination target (hereinafter, referred to as a “given target”) in a case where it is determined that the determination target corresponds to the given element.

2. The program according to claim 1,
wherein the specifying function includes a function configured to specify, in a case where an event of the video game is executed on a basis of a request from the user, an in-game element, for which an acquisition condition is satisfied in the event, as the determination target.

3. The program according to claim 1,
wherein the functions further include:
a displaying function configured to refer to the predetermined storage region to display information regarding an in-game element that corresponds to the given element among a plurality of in-game elements that appears in the video game.

4. A system for controlling progress of a video game, the system comprising a communication network, a server, and a user terminal, the system comprising:
a specifying unit configured to specify at least one in-game element as a determination target on a basis of progress of the video game;
a determining unit configured to refer to a predetermined storage region in which information regarding an in-game element that has been given to a user in the other video game (hereinafter, referred to as a “given element”) is stored, and determine whether the determination target corresponds to the given element or not; and
a giving unit configured to give the user an in-game element different from the determination target (hereinafter, referred to as a “given target”) in a case where it is determined that the determination target corresponds to the given element.

5. A program for causing a server to realize functions to control progress of a video game,
wherein the functions include:
a specifying function configured to specify at least one in-game element as a determination target on a basis of progress of the video game;
a determining function configured to refer to a predetermined storage region in which information regarding an in-game element that has been given to a user in the other video game (hereinafter, referred to as a “given element”) is stored, and determine whether the determination target corresponds to the given element or not; and
a giving function configured to give the user an in-game element different from the determination target (hereinafter, referred to as a “given target”) in a case where it is determined that the determination target corresponds to the given element.

6. The program according to claim 2,
wherein the functions further include:
a displaying function configured to refer to the predetermined storage region to display information regarding an in-game element that corresponds to the given element among a plurality of in-game elements that appears in the video game.
